(19) United States
(12) Patent Application Publication
(10) Pub. No.: US 2026/0145489 A1
(43) Pub. Date: May 28, 2026

(54) VENTILATION DEVICE FOR MOTOR VEHICLES AND ASSOCIATED MOTOR VEHICLE

(71) Applicant: AUDI AG, Ingolstadt (DE)

(72) Inventor: Jacques HÉLOT, Ingolstadt (DE)

(73) Assignee: AUDI AG, Ingolstadt (DE)

(21) Appl. No.: 19/402,480

(22) Filed: Nov. 26, 2025

(30) Foreign Application Priority Data
Nov. 27, 2024 (DE) 10 2024 135 114.4

(51) Int. Cl. B60H 1/34; B60H 1/00

(52) U.S. Cl. CPC B60H 1/3428; B60H 1/00021; B60H 1/00564; B60H 1/00871; B60H 1/00985; B60H 2001/00185

(57) ABSTRACT

A ventilation device for a motor vehicle with at least one air outlet including a main flow duct for a main airflow and with at least one device to deflect the main airflow along an airflow direction with at least one lateral air duct to enable blowing a transverse airflow into the main airflow, and an operating element to specify the airflow direction, which for the main airflow has outside of the main flow duct the transverse airflow being blown into the main airflow, by specifying a flow rate of the transverse airflow. In addition, a motor vehicle with at least one such ventilation device.

### CROSS REFERENCE TO RELATED APPLICATIONS

This application is a based upon and claims the priority benefit of German Application No. 10 2024 135 114.4 filed on Nov. 27, 2024, the entire contents of which are incorporated by reference herein.

### BACKGROUND

### 1. Field

The invention relates to a ventilation device for a motor vehicle, in particular connected to a heating or air-conditioning system, with airflow ducts, at least one air outlet and with an operating blade for controlling the direction of air through lateral air ducts. The invention also relates to a motor vehicle.

### 2. Description of the Related Art

According to DE 10 2016 004 992 B3, a ventilation device is used to conduct at least one airflow into the interior of a motor vehicle in order to enable targeted ventilation or air-conditioning of the motor vehicle interior. Usually, in the motor vehicle, a plurality of ventilation devices are arranged at different locations in order to be able to distribute the airflow as uniformly as possible in the interior of the motor vehicle.

Typically, ventilation devices are arranged in the dashboard, in the center console, near the side windows and/or in the footwell of the motor vehicle interior. In general, the ventilation devices control both the volume flow and the direction of an airflow. Usually, a ventilation device comprises an operating device, such as for example an operating wheel or an operating lever, to allow a user to set a desired volume flow or a direction of an airflow. For example, the airflow can be directed by the user in a certain direction, throttled, or completely stopped by fully shutting the closing device arranged at the ventilation device.

In this context, DE 101 21 909 A1 describes a ventilation device for vehicles, in particular connected to a heating or air-conditioning system, with airflow ducts and at least one air outlet with devices for controlling the air direction and the volume flow, wherein at least the devices for controlling the air volume flow and for controlling the air direction of the air outlet can be electrically actuated.

DE 10 2016 004 992 B3 shows a ventilation device for a motor vehicle having a first ventilation duct for guiding a first airflow via a first ventilation device opening into a motor vehicle interior, a second ventilation duct for guiding a second airflow via a second ventilation device opening into the motor vehicle interior, and a first and a second closing device, the respective degree of opening of which is adjustable by an operating device between an open and a closed position, wherein the first closing device in the closed position closes the first ventilation duct and the second closing device in the closed position closes the second ventilation duct.

To deflect the direction of the airflow, a plurality of blades arranged in parallel are usually used in vertical and horizontal directions or other blade-based geometries which can deflect the airflow in each case perpendicular to the orientation of the blade. The amount of deflection depends on the degree of deflection of the blades. Disadvantages of such a device are the busy overall look of the blades since the appearance is highly dependent on the set direction of the blades. In addition, dust easily collects on the many blades and it is difficult to clean this from the blades because of the small gaps.

A disadvantage of an electrical control system from the prior art with indirect operation by input devices such as buttons or touch screens is that blind operation is difficult or impossible because there is no haptic feedback and, for example, the setting direction can be difficult to feel by hand. In particular, touch screens do not provide feedback on what input was made.

### SUMMARY

One object of the present invention, according to an aspect of the present invention, is to provide a ventilation device which has a uniform appearance in each setting at least of the air direction.

The objects of the present invention are achieved by the subject matter of the independent claims. Advantageous further developments of the invention are described by the dependent claims, the description that follows, and the figures.

According to one aspect, the invention provides a ventilation device for a motor vehicle. The ventilation device comprises at least one air outlet, also known as a dashboard outlet, including a main flow duct for a main airflow and with at least one device to deflect the main airflow along an airflow direction with at least one lateral air duct to enable blowing a transverse airflow into the main airflow, and an operating element to specify the airflow direction, which the main airflow has outside of the main flow duct the transverse airflow being blown into the main airflow, by specifying a flow rate of the transverse airflow.

In other words, according to one aspect of the invention, the direction of an airflow at the exit from an air outlet in a motor vehicle is changed when an input medium is actuated by at least one transverse airflow or deflection airflow being generated transversely to the main airflow, which then causes the deflection of the main airflow. The term "transverse airflow" is intended to mean that the respective transverse airflow from its lateral air duct exits transversely or at least obliquely to that airflow direction which the main airflow has in the main flow duct, wherein "obliquely" is preferably intended to be an angle of at least 20°, preferably at least 45°, between the pulse vectors. In this case, the pulse vectors of the main and deflection airflow add up to a desired direction outside the air outlet in the vehicle interior, taking into account usual physical inaccuracies.

This results in the advantage that the ventilation device can always have the same appearance, irrespective of the direction in which the airflow is currently deflected, since the deflection is only caused by one or more transverse airflows and not, as usual, by the mechanical adjustment of a plurality of parallel, orthogonal, or concentric blades. This makes the outer part of the air outlets easy to clean as the many small gaps between the blades are no longer present. In this case, all the mechanical parts that are necessary to influence the strength of the airflows in the at least one lateral air duct and thus to control the direction of the main airflow are preferably not visible from outside and are thus housed in the interior of the ventilation device securely from external mechanical influence.

The main flow duct can, for example, be a central duct through which a main airflow for supplying the vehicle interior with fresh air flows and can preferably have a larger cross-sectional area than a respective lateral air duct which generates a transverse airflow. The main airflow can pass from the main air duct into the vehicle interior at an air outlet. For example, a lateral air duct can be arranged next to the main air duct and can be equipped with a flap, for example, in order to be able to control the flow rate in the lateral air duct independently of the main airflow. The operating element for specifying the airflow direction can be any type of input medium, in particular a switch, joystick, or touch screen.

In one preferred embodiment of the invention, the operating element is configured as an operating blade which is arranged in the main flow duct and has at least one further air duct for blowing a further transverse airflow into the main airflow.

In other words, the operating element can have a flat geometry such that air can easily flow around the element, and itself has at least one cavity or air duct in which an airflow can flow. At an outlet of this air duct, this airflow is then deflected in a direction obliquely or even transversely to the main airflow and thus influences the deflection of the main airflow in addition to the respective lateral air duct in the air outlet

One advantage of this is that the operating blade can fit into the air outlet. This allows a user to follow the airflow in reverse in the case of blind operation by feeling by hand and to be able to take hold of the operating blade or have to look at the operating element. The operating blade also offers enough space for at least one air duct which generates a further transverse airflow for the uniform deflection of the main airflow and thus simultaneously serves as a mechanical component.

The operating blade can include, for example, a mechanical or electrical switch which influences the flow rate of the respective transverse airflows in the lateral air duct and in the operating blade itself, and thus specifies the airflow direction.

In a further development, according to an aspect of the invention, the connection of the at least one air duct in the operating blade to the air supply duct located behind the operating blade as viewed from the outflow opening is configured as movable and consequently forms at least one continuous and movable/deformable air duct.

In other words, the air duct, which also passes through the operating blade, can be connected to the upstream part of the air duct (air supply duct) in such a way that the operating blade can move in at least one direction despite the continuous air duct.

This results in the advantage that the operating blade can be deflected for specifying an airflow direction in a direction, in particular the direction of the specified airflow direction, without an air supply in the air duct located therein being interrupted. A movable connection can also be advantageous because the flow rate of the at least one airflow in the operating blade must be settable independently of the main airflow, but the operating blade is situated within the main airflow. The volume flows of the main airflow and the respective transverse airflow (and also that from a lateral air duct) can preferably be controlled separately from each other in order to set the final airflow direction, which is why an air duct for the operating blade, separate from the main flow duct, is advantageous. The flexible connection of the operating blade to the air duct located behind it can also allow the operating blade to be deflected as an input method, even if this is not necessary in the case of all the input methods such as, for example, touch detection or force detection.

The movable connection of the at least one air duct in the operating blade and of the air duct located behind it can be, for example, a flexible plastic duct section, a flexible hose, or a link pipe system.

In a further embodiment, according to an aspect of the invention, it is provided that the operating blade maintains a monostable position by means of at least one elastic restoring element.

In other words, the operating blade can have a single position to which the operating blade returns after actuation in any direction since a restoring element, i.e. for example a flexible return mechanism, exerts a force on the operating blade as long as it is not situated in the initial position.

The advantage of this is that the operating blade can always be arranged in the optimum position parallel to the main flow duct and thus impede the airflow to the least extent. In addition, the uniform position results in a completely uniform appearance of the air outlet, including the operating element, wherein even small deflections can be avoided.

The restoring element can be formed here as a restoring spring which is made of, for example, plastic or metal or it can be a part of the suspension of the operating blade itself, which can be manufactured from an elastic material. The connection of the at least one air duct in the operating blade to the airflow duct itself, which is located behind the operating blade as viewed from the outflow opening, can be designed not only as movable but also as elastic such that a restoring force can be exerted on the operating blade when the latter is deflected.

A further advantageous embodiment can provide that the operating blade has a mechanical spindle is which is continuous or interrupted and on which the operating blade is rotatably mounted and is consequently deflectable, as a result of which the specification of the airflow direction which the main airflow has outside of the main flow duct is electrically and/or mechanically detectable.

In other words, the operating blade can have a mechanical suspension which allows the operating blade to rotate about a mechanical spindle, as a result of which a tilting movement of the operating blade is enabled which can be used to specify the airflow direction.

An advantage of this embodiment is that such a spindle provides a stable connection with simultaneous smooth rotation about the spindle. In addition, the spindle allows the two sides of the operating blade, in front of and behind the spindle as viewed from the outflow opening, to be used as a lever for actuating a switch.

The spindle can be designed, for example, as a plastic or metal pin. It can be arranged, for example, in the rear area of the operating blade, as a result of which the front edge of the operating blade, i.e. the side facing the air exit point of the air outlet, is enabled to deflect in order to specify the airflow direction. Alternatively, the spindle can be divided into two or more parts and, for example, fasten the operating blade only at the top and bottom, as a result of which an area is created in the center in which, for example, the at least one air duct in the operating blade can be connected to an air duct located behind it.

In a further development, it is provided that the operating blade is configured to be shifted on the spindle parallel to the spindle and consequently to specify at least one further airflow direction.

In other words, in addition to the tilting movement about the spindle, the operating blade can perform a lateral slip movement on the spindle, wherein at least one further switch is actuated which specifies the airflow direction.

This results in the advantage that not only can the operating blade be adjusted in two directions about the spindle, as a result of which the specification of the flow direction of the main airflow can preferably be input in the respective direction of the deflection (for example, to the left and right, if the spindle is oriented vertically), but an input which can trigger, for example, a deflection of the airflow up and down (in the case of a vertical spindle) can also be made parallel to the spindle. The movement of the blade can here be limited to the required length in order to be able to actuate the switch, in particular to 0.5–1.5 mm. A length of movement parallel to the spindle which is sufficient to generate haptic feedback is also advantageous.

In a further development, it is provided that each lateral air duct in the air outlet and each air duct in the operating blade are each configured to together deflect the main airflow in the same direction by the respective generated transverse airflows flowing in the same direction

In other words, two air ducts can always form a pair in order to deflect the main airflow, wherein one of the air ducts is situated in the operating blade and one on the side of the main flow duct.

The advantage of this is that the main airflow is always deflected from two sides, thus creating a more uniform deflected, less turbulent airflow than with just one transverse airflow. In addition, rushing noise can be reduced as a lower volume of air has to be deflected per transverse airflow than with a single transverse airflow. Since the operating blade can be situated in the main flow duct, it divides the main airflow into two parts such that with this arrangement of the air ducts and the associated transverse airflows, each transverse airflow can deflect each part of the main airflow. In addition, depending on the length, shape, and position, the operating blade could partially block a transverse airflow which blows in the direction of the operating blade such that the paired transverse airflow from the operating blade, which blows in the same direction, can maintain the deflection of the main airflow.

In a further embodiment, the operating element can have at least one switch which generates a haptic click when the operating element is actuated in at least one direction.

In other words, at least one switch in or on the operating element can give tactile and/or audible feedback when the operating element is deflected in at least one direction.

The advantage of this is that blind operation is further improved by allowing the operator to hear and/or feel whether the operation of the operating element and thus the specification of the direction of the air has been successful, as a result of which traffic safety is increased because the driver of the motor vehicle does not have to look at the operating element or the air outlet in order to operate it. The combination of an operating element designed as an operating blade with the switch described here, which generates a haptic click when actuated, is particularly advantageous.

The switch in the operating element can be, for example, a microswitch which distinguishes at least two different positions and sends the signal, for example, to a control unit which then controls the flow velocity in at least one transverse airflow. Alternatively, the signal can be transmitted purely mechanically via, for example, rods, levers, and gears, wherein the switch also has a mechanical form. The haptic click can be a perceptible short vibration and/or an audible short noise, which serves as feedback for successful input, as is known in the case of many switches in the prior art.

In a further development, it is provided that the operating element also has an input medium for setting the air volume flow which flows through the air outlet.

In other words, not only can the direction of the airflow be specified at the operating element, but also the amount of air which flows out of all the airflow ducts together per unit time.

This results in the advantage that the air volume flow which is intended to flow out of this air outlet can also be specified directly at the respective air outlet. This is advantageous because the flow rate of each air outlet can be set individually and the assignment between the operating element and the corresponding air outlet is clear for an operator, which is not necessarily the case with a spatially separate operating element. The operating element can thus simultaneously be used to specify the direction of the airflow and the air volume flow and can be operated with one hand.

For example, the input medium can, for example, be a switch which differentiates between two positions and consequently allows “on” and “off” modes to be specified in order to interrupt or switch on the airflows. Alternatively, the input medium can be, for example, a dial or slider which additionally allow specification of the air volume flow with a plurality of intermediate levels between "on" and "off" or continuously variable specification. In particular, the input medium can be arranged directly on the operating blade.

In a further development, it is provided that the ventilation device has a lighting device and a control unit controlling the lighting device is provided, wherein the control unit is configured to activate the lighting device depending on the set air direction and/or air volume flow in order to emit an optical signal.

In other words, the ventilation device can have a lighting device or optical display which can be activated by a control unit in order to indicate the direction or the volume flow of a respective airflow.

This can be particularly advantageous because, in particular in the case of a monostable mounted operating blade, it is not possible to identify in what direction the airflow is deflected from the position of a deflection device, such as for example blades, as is the case with conventional ventilation devices. Therefore, a display device allows a user to identify the direction or intensity of the airflow, even though the position of the operating element, in particular an operating blade, is not identifiably related to the air direction and can furthermore have a monostable position.

The lighting device can comprise, for example, LEDs (light-emitting diodes) or a symbol or graphic display which directly or indirectly transmit an optical signal into the vehicle interior by, for example, fiberoptic cables.

In a further development, it is provided that the specification of the air direction can be set at an intermediate level or a plurality of intermediate levels by the flow rate of the respective transverse airflow being configured as incrementally modifiable with each actuation of the operating element.

In other words, the operating element can be configured such that not only can the deflection of the main airflow by a respective transverse airflow be switched on or off, but also the strength of the deflection can be specified at more than these two levels (on/off).

This gives the advantage that a user in a vehicle with such a ventilation device has a greater variety of options to optimally set the direction of the airflow than with just a two-level control system.

The motor vehicle according to the invention preferably takes the form of an automobile, in particular a car or a truck, or a minibus or motorcycle. The motor vehicle according to the invention comprises at least one ventilation device according to one of claims 1-11.

The invention also comprises the combinations of the features of the embodiments described. The invention thus also comprises implementations which each have a combination of the features of a plurality of the embodiments described, unless the embodiments have been described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

Exemplary embodiments of the invention are described below, in which:

FIG. 1 shows a 3D schematic diagram of a ventilation device according to an embodiment of the invention;

FIG. 2 shows view in section through an air outlet with two lateral air ducts according to one embodiment of the invention;

FIG. 3 shows a view in section through an air outlet according to one embodiment of the invention, with an operating element which is designed as an operating blade and has two further air ducts which have a deformable connection at the rear.

FIG. 4 shows a further view in section, as in FIG. 3, and in panel 4A an undeflected main airflow flowing in a straight line and an operating blade in a neutral position, in panel 4B a section with a deflected operating blade, wherein a microswitch is actuated, in panel 4C a section in which the operating blade has returned to the neutral, monostable position and now two transverse airflows, one in a lateral air duct and one in the operating blade, deflect the main airflow to the right

FIG. 5 shows a perspective illustration of an embodiment of an air outlet according to the invention, with an operating blade and a switch for specifying the air volume flow;

FIG. 6 shows a perspective illustration of another embodiment of an air outlet according to the invention, here with a visible vertical spindle and a dial for specifying the air volume flow;

FIG. 7 shows a motor vehicle with a ventilation device according to one embodiment of the invention and airflows which are deflected in different directions.

### DETAILED DESCRIPTION

Reference will now be made in detail to the preferred embodiments, examples of which are illustrated in the accompanying drawings, wherein like reference numerals refer to like elements throughout.

The exemplary embodiments explained below are preferred embodiments of the invention. In the exemplary embodiments, the described components of the embodiments are in each case individual features of the invention which are to be considered independently of one another and which in each case also develop the invention independently of one another. Therefore, the disclosure is intended to also comprise combinations of the features of the embodiments other than those illustrated. Furthermore, the embodiments described can also be supplemented by further features of the invention which have already been described.

In the figures, identical reference signs denote functionally identical elements in each case.

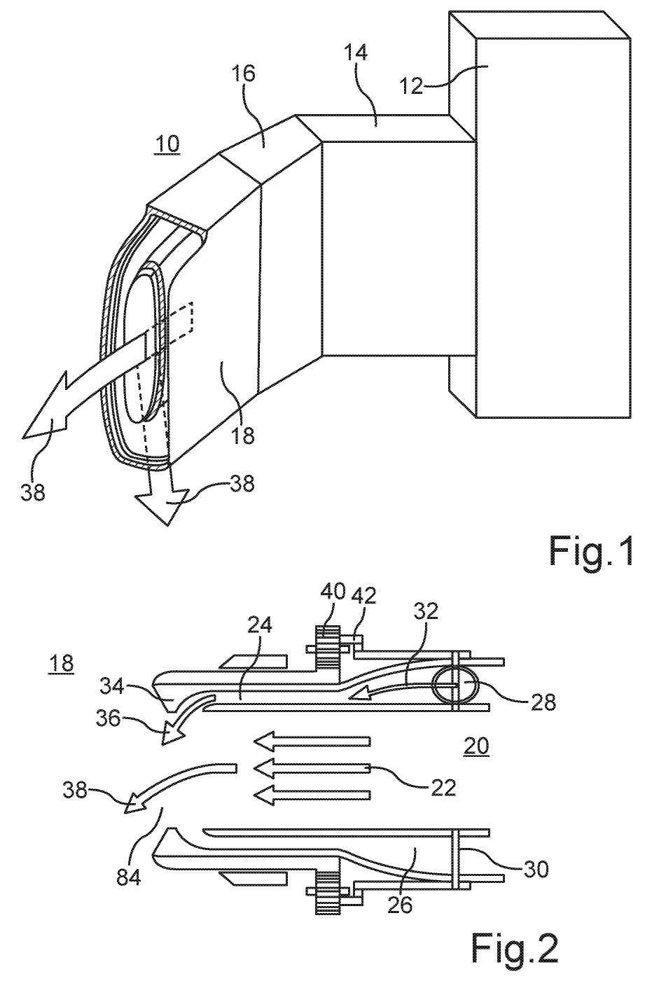

FIG. 1 shows a ventilation device 10 with a heating/air-conditioning system 12, an air supply duct 14, an air volume flow control system 16, and an air outlet 18.

In this exemplary embodiment, the temperature of the air is controlled in the heating/air-conditioning system and then flows through the air supply duct 14 in the direction of the air outlet 18, where the airflow leaves the ventilation device, for example in the direction of a vehicle interior. Depending on the specification, the direction 38 of the airflow can be changed when leaving the air outlet 18 by the air volume flow control system 16.

FIG. 2 shows a section through an embodiment of the air outlet 18 along the direction of the airflow and in, for example, a horizontal or vertical direction with a main flow duct 20 in which a main airflow 22 flows, and two lateral airflow ducts 24, 26 with an open flap 28 in the first lateral air duct 24, which allows the passage of a lateral airflow 32, and a closed flap 30 which blocks the airflow in the second lateral airflow duct 26. At the outlet 34 of the upper airflow duct, the lateral airflow 32 can be deflected and thus become a transverse airflow 36 which can deflect the main airflow 22 at the outflow opening 84 of the air outlet and can join said main airflow to form a final deflected airflow which flows in the desired airflow direction 38.

In this example, there can be a mechanical operating element 40 which can move the flap 28 and/or the flap 30 via mechanical elements such as, for example, at least one gear, at least one rod and/or at least one lever 42 and thus can influence the size of the volume flow of the transverse airflow 36 and/or the airflow in the flow duct 26. The flow rate of the volume flows in the air ducts could also be controlled electronically, for example by means of flaps which are adjustable by means of at least one electric motor.

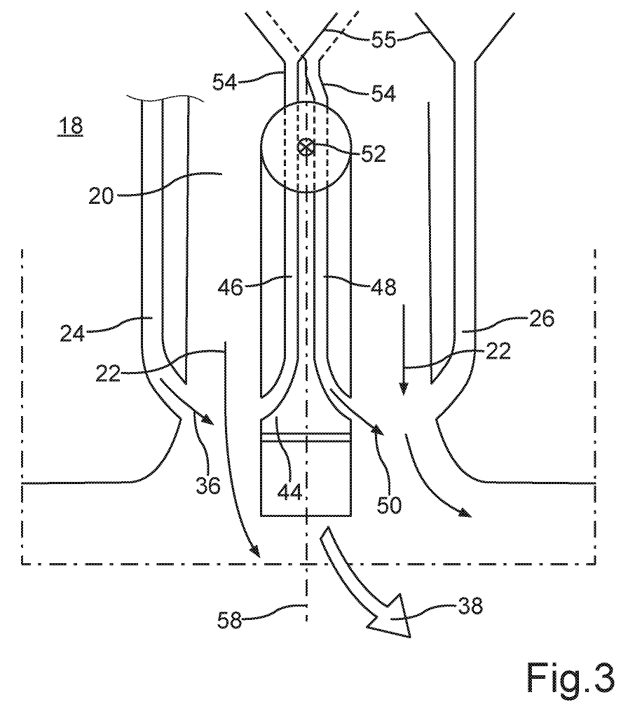

FIG. 3 shows a section through the air outlet 18 along the main flow duct 20 and transversely through an operating blade 44, with lateral air ducts 24, 26 and a transverse airflow 36. In this example, two further air ducts 46, 48 can be seen in the operating blade 44. For example, a further transverse airflow 50 can flow from the air duct 48. The operating blade 44 can have a mechanical spindle 52, for example a metal pin, at the rear end. In addition, two deformable connections 54 are shown, for example hoses, which can connect the two air ducts 46, 48 in the operating blade 44 to an air volume flow control system 16 in which, for example, the volume flow of each air duct can be individually controlled.

The example in FIG. 3 shows how a main airflow 22 can be deflected in a direction 38 without the operating blade 44 having to leave a neutral central position 58 by two transverse airflows 36, 50 from a lateral air duct 24 and a further air duct 48 in the operating plate 44 itself deflecting the main airflow 22, in this example to the right. Alternatively, the main airflow 22 in FIG. 3 could be deflected to the left if the airflows in the two other air ducts 26, 46 were to be switched on and the transverse airflows 36 and 50 were to be switched off. The strength of the transverse airflows (i.e. their volume flow or flow rate) can here influence the strength or degree of deflection of the main airflow (angular difference from the direction of the main flow duct) and consequently specify the direction 38 such that, with the arrangement shown in FIG. 3, the direction 38 can be settable in a continuously variable fashion.

The cross-sectional view shows only air ducts for deflecting the main air flow in two directions, in this example right and left, but further air ducts, for example for deflection up and down, are possible.

In this exemplary embodiment, each lateral air duct 24, 26 can, together with an air duct 46, 48 in the operating plate 44, be configured to deflect the main airflow 22 in the same direction by the respective generated transverse airflows 36, 50 flowing in the same direction. Thus, according to the illustration in section of FIG. 3, the air ducts 24 and 48 deflect the airflow to the right and the ducts 26 and 46 to the left in order together to allow a more uniform and thus less turbulent deflection of the main airflow, in particular on the rear side of the operating plate 44 as seen from the lateral transverse airflow 36, where a shadowing of the transverse airflow 36 could occur with only one airflow for deflecting the main airflow 22. Alternatively, the operating blade 44 could be located lower in the main flow duct 20 and thus shadow the transverse airflows 36 from lateral air ducts 24, 26 to a lesser extent. For easier operation, i.e. to make the operating blade 44 easier to grasp, only a part of the operating blade could be longer and protrude from the front of the air outlet 18.

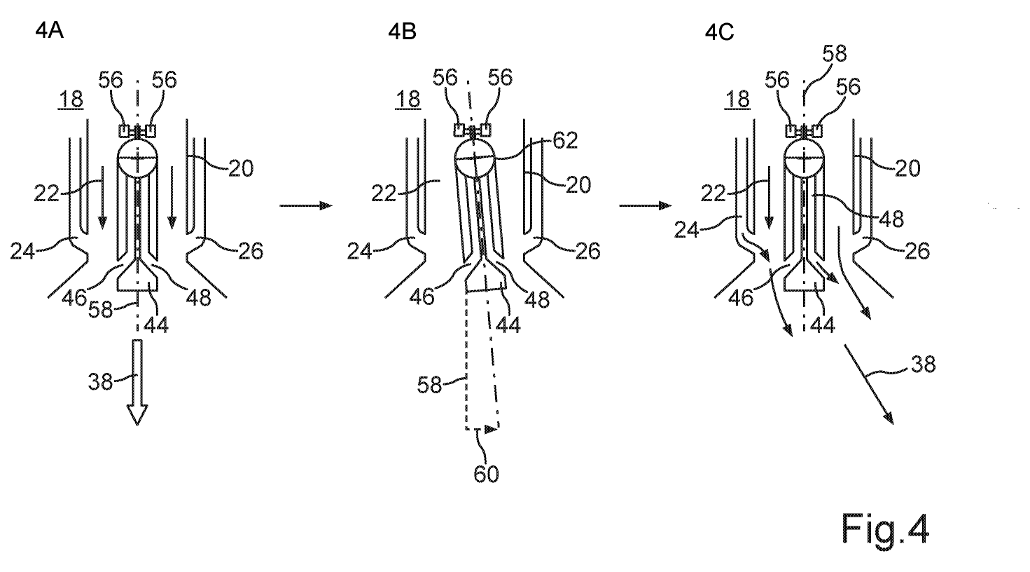

FIG. 4 shows a section through an exemplary embodiment similar to FIG. 3 with an air outlet 18 which has a central operating blade 44. Analogously to FIG. 3, air ducts 24, 26, 46, 48 for deflecting the main airflow 22 are visible. In panel 4A, none of the transverse airflows is switched on and the main airflow 22 can flow out of the air outlet 18 in a straight direction 38. In addition, the mechanical spindle 52 of the operating blade 44 is shown, next to which in this exemplary embodiment in each case one switch 56 can be situated for each possible deflection direction. In panel 4B, such a deflection 60 of the operating blade 44, here to the right, is shown, as a result of which one of the switches 56 is actuated. The panel 4C then shows how a restoring element 62 can return the operating blade 44 to the central position 58 immediately after the deflection 60. The actuation of the switch 56 can then cause the opening of the air ducts 24 and 48, as a result of which two transverse airflows 36 and 50 are switched on and the main airflow 22 can be deflected to the right, for example. For example, the strength of the transverse airflows 36, 50 can become incrementally stronger the more often the operating blade 44 is deflected in the desired direction 60 and can become weaker when the operating blade 44 is deflected in the opposite direction. In the case of the deflection 60 of the operating blade 44, the switch 56 can give feedback or haptic feedback in the form of a vibration, i.e., for example, the click feeling when switching, and/or an audible click noise in order to signal that the input of the desired airflow direction 38 has been successful. Alternatively, the operating blade can be immovable and can have a vibrating motor which can generate haptic feedback. The switch could in the embodiment have a touch sensor or a force sensor which is configured to measure a touch or the exertion of force on the operating blade.

This procedure shows how the operating blade can be used to set a desired airflow direction 38 without permanently deflecting the position of one or a plurality of blades which change the airflow directly by means of their position, from a neutral position, as in the prior art. The operating blade 44 can thus serve as an input medium for the strength and direction of the transverse airflows and at the same time, but not necessarily, itself contribute to the deflection of the main airflow by air ducts 46, 48.

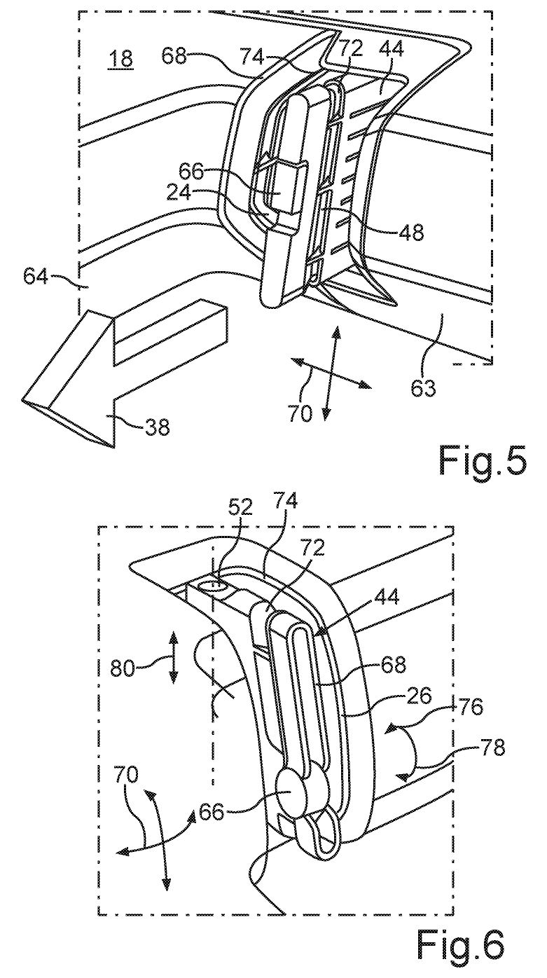

In FIG. 5, a perspective illustration of an embodiment is shown, with an air outlet 18 and an operating blade 44. In this example, the air outlet 18 is inserted into the dashboard 63 of a motor vehicle 82 and is situated next to the vehicle door 64. The operating blade 44 has an input medium 66, for example a slider, which can turn the entire air volume flow which flows out of the air outlet, on or off. The exemplary operating blade can be deflected in the indicated directions 70 up/down/right/left in order to set the desired airflow direction 38. In this exemplary embodiment, an LED contour light 68, which can, for example, indicate the direction 38 of the currently set airflow, is situated at the outer edge. Also illustrated in FIG. 5 are a lateral air duct 24 and an air duct 48 of the operating blade 44.

In the perspective view of FIG. 5 it is also shown how the operating blade 44 can be deflected not only in two but in four directions 70 in order to set the direction 38 of the airflow. When deflected upward, air would then flow out of the upper air duct 72, for example. Since the operating blade also has a switch 66 for setting the air volume flow, in this exemplary embodiment a user can set the air direction and/or the strength of the air volume flow with one hand without having to look at the air outlet 18.

FIG. 6 shows a perspective illustration of a further embodiment of the air outlet 18 with an operating blade 44, in which the spindle 52 of the operating blade is visible at the top. The input medium 66 for setting the air volume flow is designed here as a dial and allows stepless adjustment of the air volume flow when turning the dial in two directions 76, 78 and switching-off of the air volume flow, for example in the "off" position. Also in this embodiment, lateral air ducts 26, 74 are visible, wherein the air duct 26 can effect a deflection of the main airflow 22 to the left and the air duct 74 can effect a deflection upward. The spindle 52 of the operating blade 44 can be designed such that the entire operating blade can be deflected along the spindle 52 in order to actuate a switch 56 at the spindle 52 and, for example, to be able to set the desired airflow direction 38 in the same direction of deflection 80. In one embodiment, a lighting device 68, for example in the form of an LED contour light, can be installed along the front edge or end face of the operating blade 44.

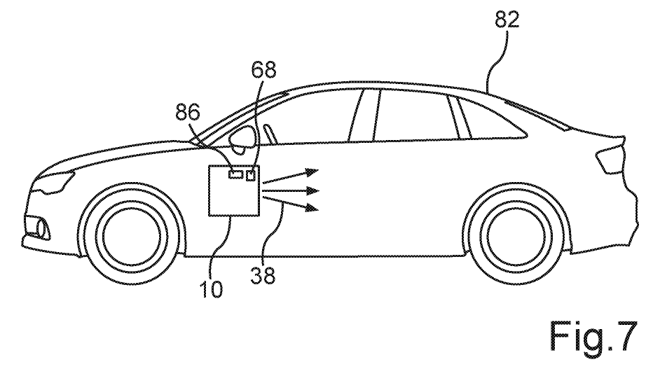

Finally, FIG. 7 shows a motor vehicle 82, for example a car, with a ventilation device 10 of the described type and several possible airflow directions 38. The ventilation device 10 can comprise a lighting device 68 and a control unit 86 controlling the lighting device 68, wherein the control unit 86 can be configured to activate the lighting device 68 depending on a respective set air direction 38 and/or an air volume flow in order to emit a respective optical signal.

In a preferred embodiment, the air nozzle (air outlet) 18 has no blades, wherein the air is directed via lateral airflows (transverse airflows) 36, 50.

There may be a central pipe (main flow duct) 20 through which the main airflow 22 flows. For example, four lateral, narrower air ducts 24, 26 can blow onto the pipe, for example in a 3, 6, 9, and 12 o'clock orientation. At the end (outlet) 34 of the respective ducts, near the outflow opening 84 of the central pipe 20, the airflow can be deflected toward 3, 6, 9, and 12 o'clock, by approximately 45° to 60°. If the air is passed through the 9 o'clock duct, the main airflow 22 can be influenced and flow toward 3 o'clock. If the air is passed through the 12 o'clock duct, the resulting flow can move toward 6 o'clock.

In one embodiment, a central operating blade 44, which has a neutral position (monostable position) 58, can be situated in the center of the outlet (air outlet) 18. The operating blade 44 can be easily moved left/right/up/down 70. When the operating blade 44 moves, haptic feedback (a haptic click) can be generated, for example, by means of a microswitch 56. After the movement (deflection) 60, the air can be directed in the manner input by the user. LEDs (a lighting device) 68 can indicate the direction 38 of the airflow. The operating blade 44 can return to the neutral position 58 after the movement 60.

An advantage of such a design would be that the nozzle 18 always looks the same, irrespective of how the airflow direction 38 is set, and that the device is easy to operate, for example by means of the haptic feedback. Moreover, there are, for example, no visible moving parts in the air nozzles 18 which can break quickly. The sensitive parts can be arranged inside in a protected fashion.

Overall, the examples show how a monostable operating blade with haptic feedback can be provided for directing air in an outlet.

A description has been provided with particular reference to preferred embodiments thereof and examples, but it will be understood that variations and modifications can be effected within the spirit and scope of the claims which may include the phrase "at least one of A, B, and C" as an alternative expression that means one or more of A, B, and C may be used, contrary to the holding in Superguide v. DIRECTV, 358 F3d 870, 69 USPQ2d 1865 (Fed. Cir. 2004).

What is claimed is:

1. A ventilation device for a motor vehicle, comprising:
at least one air outlet including:
a main flow duct for a main airflow,
at least one device to deflect the main airflow along an airflow direction with at least one lateral air duct to enable blowing a transverse airflow into the main airflow, and
an operating element to specify the airflow direction, which is intended for the main airflow outside of the main flow duct, the transverse airflow being blown into the main airflow, by specifying a flow rate of the transverse airflow.

2. The ventilation device as claimed in claim 1, wherein the operating element is configured as an operating blade which is arranged in the main flow duct, and has at least one further air duct to enable blowing a further transverse airflow into the main airflow.

3. The ventilation device as claimed in claim 2, wherein a connection of the at least one further air duct in the operating blade to an air supply duct located behind the operating blade as viewed from an outflow opening is configured as movable and consequently forms at least one continuous and movable/deformable air duct.

4. The ventilation device as claimed in claim 2, wherein the operating blade maintains a monostable position by at least one elastic restoring element.

5. The ventilation device as claimed in claim 3, wherein the operating blade maintains a monostable position by at least one elastic restoring element.

6. The ventilation device as claimed in claim 2, wherein the operating blade has a mechanical spindle which is continuous or interrupted and on which the operating blade is rotatably mounted and is consequently deflectable, as a result of which the airflow direction, which the main airflow has outside of the main flow duct the transverse airflow being blown into the main airflow, is electrically and/or mechanically detectable.

7. The ventilation device as claimed in claim 3, wherein the operating blade has a mechanical spindle which is continuous or interrupted and on which the operating blade is rotatably mounted and is consequently deflectable, as a result of which the airflow direction, which the main airflow has outside of the main flow duct the transverse airflow being blown into the main airflow, is electrically and/or mechanically detectable.

8. The ventilation device as claimed in claim 4, wherein the operating blade has a mechanical spindle which is continuous or interrupted and on which the operating blade is rotatably mounted and is consequently deflectable, as a result of which the airflow direction, which the main airflow has outside of the main flow duct the transverse airflow being blown into the main airflow, is electrically and/or mechanically detectable.

9. The ventilation device as claimed in claim 6, wherein the operating blade is configured to be shifted on the mechanical spindle parallel to the mechanical spindle and consequently to specify at least one further airflow direction.

10. The ventilation device as claimed in claim 2, wherein each at least one lateral air duct in the at least one air outlet and each at least one further air duct in the operating blade are configured to deflect together the main airflow in a same direction by respectively generated transverse airflows flowing in the same direction.

11. The ventilation device as claimed in claim 3, wherein each at least one lateral air duct in the at least one air outlet and each at least one further air duct in the operating blade are configured to deflect together the main airflow in a same direction by respectively generated transverse airflows flowing in the same direction.

12. The ventilation device as claimed in claim 4, wherein each at least one lateral air duct in the at least one air outlet and each at least one further air duct in the operating blade are configured to deflect together the main airflow in a same direction by respectively generated transverse airflows flowing in the same direction.

13. The ventilation device as claimed in claim 5, wherein each at least one lateral air duct in the at least one air outlet and each at least one further air duct in the operating blade are configured to deflect together the main airflow in a same direction by respectively generated transverse airflows flowing in the same direction.

14. The ventilation device as claimed in claim 6, wherein each at least one lateral air duct in the at least one air outlet and each at least one further air duct in the operating blade are configured to deflect together the main airflow in a same direction by respectively generated transverse airflows flowing in the same direction.

15. The ventilation device as claimed in claim 1, wherein the operating element has an input medium to set a total air volume flow which flows through the at least one air outlet.

16. The ventilation device as claimed in claim 2, wherein the operating element has at least one switch which generates a haptic click based on the operating blade being actuated in at least one direction.

17. The ventilation device as claimed in claim 1, comprising:
a lighting device, and
a control unit to control the lighting device, wherein the control unit is configured to activate the lighting device depending on a respective set airflow direction and/or an air volume flow in order to emit a respective optical signal.

18. The ventilation device as claimed in claim 1, wherein the specification of the airflow direction is settable with an intermediate level or at a plurality of intermediate levels by the flow rate of the transverse airflow being configured as incrementally modifiable with each actuation of the operating element.

19. A motor vehicle comprising at least one ventilation device as claimed in claim 1.
